(19) United States
(12) Patent Application Publication
(10) Pub. No.: US 2012/0229483 A1
(43) Pub. Date: Sep. 13, 2012

(54) PANEL DRIVING DEVICE AND DISPLAY DEVICE HAVING THE SAME

(75) Inventors: HUNG LI, Taipei City (TW); JUN REN SHIH, Hsinchu City (TW); YU CHAO CHANG, Changhua County (TW); FENG LI LIN, Hsinchu County (TW); CHIN CHIEH CHAO, Hsinchu City (TW)

(73) Assignee: RAYDIUM SEMICONDUCTOR CORPORATION, HSINCHU (TW)

(21) Appl. No.: 13/412,828

(22) Filed: Mar. 6, 2012

(30) Foreign Application Priority Data
Mar. 11, 2011 (TW) 100108228

(51) Int. Cl. G09G 5/39

(52) U.S. Cl. 345/531

(57) ABSTRACT

A panel driving device for driving a display panel including N data lines is disclosed. The panel driving device includes a memory array and a source driver. The memory array includes M memory blocks, a controller and an output unit. Each memory block includes N memory units. The controller is configured to divide serial image data into M groups of sub-image data and write each group of sub-image data into the corresponding memory block sequentially, wherein each group of sub-image data has N sub-image data. The output unit is configured to output the data in the M memory blocks sequentially in a time division manner in response to a selection signal. The source driver includes N driving units having the same configuration. After the driving unit receives the time-divided data output from the output unit, signal processing is performed to generate an image signal to be output to the corresponding data line.

### BACKGROUND

1. Technical Field

The present disclosure relates to a panel driving device and a display device having the same.

2. Related Art

Flat panel display devices have the advantages of light weight, small volume, low working voltage, low power consumption and low radiation, etc., and have become the mainstream of display devices recently. Flat panel display devices are suitable for portable electronic devices, for example for use in the screens of notebook computers, cellular phones and personal digital assistants (PDAs), to display image information. Flat panel display devices commonly available in the market presently include liquid crystal display devices and plasma display devices. Besides, electro-luminescense (EL) panel technology is currently under development.

FIG. 1 is a schematic block diagram illustrating a prior art liquid crystal display device 10. The display device 10 includes a timing controller 12, a source driver 14, a gate driver 16 and a liquid crystal display (LCD) panel 18. Referring to FIG. 1, a video processing system 11 transmits image data signals R, G and B (hereafter “RGB”) and a control signal including a clock signal, a horizontal synchronization signal and a vertical synchronization signal to the timing controller 12. The timing controller 12 regroups and transmits the RGB data to the source driver 14. Meanwhile, the timing controller 12 outputs necessary control signals to the source driver 14 and the gate driver 16.

FIG. 2 is a schematic block diagram illustrating a typical source driver 14. Referring to FIG. 2, the source driver 14 includes a first data latch block 142, a second data latch block 144, a multiplexer (Mux) 146, a level shifting circuit 148, a digital to analog converter (DAC) 150 and an output buffer block 152. The first data latch block 142 includes a plurality of latches, which are configured to store the regrouped image data output from the timing controller 12 in sequence. The second data latch block 144 includes a plurality of latches, which are configured to simultaneously store the data output from the first data latch block 142 in response to a latching signal LAT. The multiplexer 146 outputs sub-image data to be displayed sequentially in a time division manner The level shifting circuit 148, the digital to analog converter 150 and the output buffer block 152 perform signal processing on the sub-image data, which are then concurrently output to a plurality of data lines D_{O}-D_{N} to provide the information displayed by the liquid crystal display panel 18.

In the prior art configuration, the first data latch block 142 and the second data latch block 144 are required to contain a plurality of latches to latch bit data of a plurality of sub-image data. The source driver 14 requires the multiplexer 146 to select the sub-image data to be output each time from the plurality of latches of the second data latch block 144. Therefore, the source driver 14 in the prior art configuration has a complicated circuit structure which requires a large amount of layout area during implementation.

Hence, it is desirable to provide an improved panel driving device and a display device having the same to solve the foregoing problems.

### SUMMARY

The present invention discloses a panel driving device for driving a display panel including N data lines. According to an embodiment, the panel driving device includes a memory array and a source driver. The memory array includes M memory blocks, a controller and an output unit. Each memory block includes N memory units. Each memory unit is configured to store data of D bits. The controller is configured to divide serial image data into M groups of sub-image data, and write each group of sub-image data into the corresponding memory block in sequence, wherein each group of sub-image data has N sub-image data, and each sub-image data has a data length of D bits. The output unit is configured to output the data in the M memory blocks in sequence in a time division manner in response to a selection signal. The source driver includes N driving units having the same configuration, and each driving unit includes a first latch, a second latch and a conversion unit. The first latch is configured to receive and latch the time-divided data of the output unit. The second latch is configured to latch the data output from the first latch in response to a latching signal. The conversion unit is coupled to one of the N data lines, and is configured to convert the data output from the second latch into an image signal, which is output to the corresponding data line.

The present invention discloses a panel display device. According to an embodiment, the panel display device includes a display panel having N data lines, a memory array and a source driver. The memory array includes M memory blocks, a controller and an output unit. Each memory block includes N memory units. Each memory unit is configured to store data of D bits. The controller is configured to divide serial image data into M groups of sub-image data, and write each group of sub-image data into the corresponding memory block in sequence, wherein each group of sub-image data has N sub-image data, and each sub-image data has a data length of D bits. The output unit is configured to output the data in the M memory blocks in sequence in a time division manner in response to a selection signal. The source driver includes N driving units having the same configuration, and each driving unit includes a first latch, a second latch and a conversion unit. The first latch is configured to receive and latch the time-divided data of the output unit. The second latch is configured to latch the data output from the first latch in response to a latching signal. The conversion unit is coupled to one of the N data lines, and is configured to convert the data output from the second latch into an image signal, which is output to the corresponding data line.

The foregoing has outlined rather broadly the features and technical advantages of the present invention in order that the detailed description of the invention that follows may be better understood. Additional features and advantages of the invention will be described hereinafter, which form the subject of the claims of the invention. It should be appreciated by those skilled in the art that the conception and specific embodiment disclosed might be readily utilized as a basis for modifying or designing other structures or processes for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

The objectives and advantages of the present invention will become apparent upon reading the following description and upon reference to the accompanying drawings in which:

FIG. 1 is a schematic block diagram illustrating a prior art liquid crystal display device;

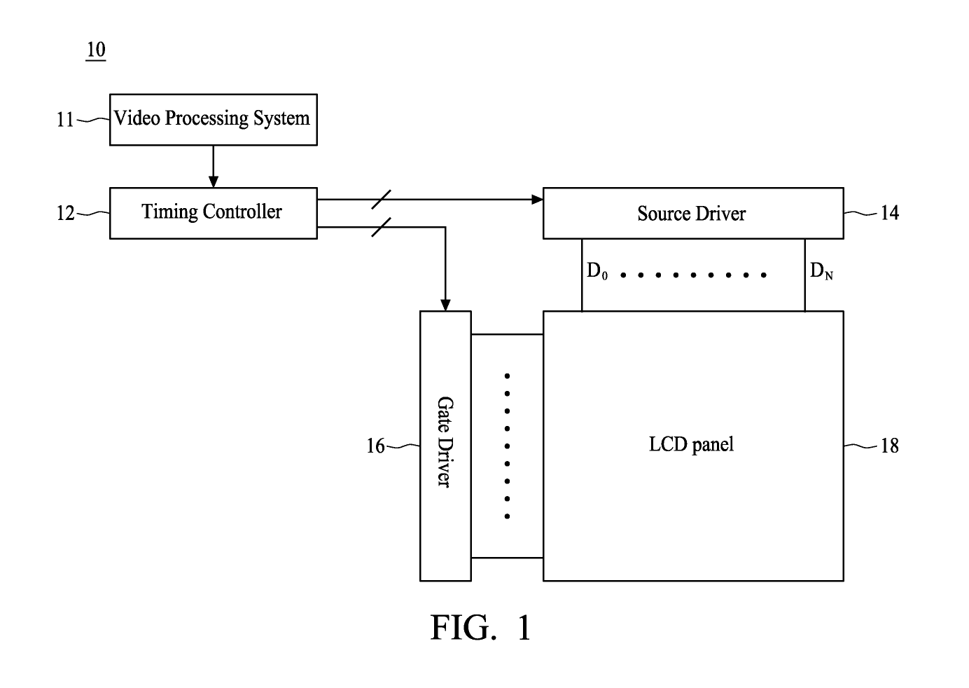

FIG. 2 is a schematic block diagram illustrating a typical source driver;

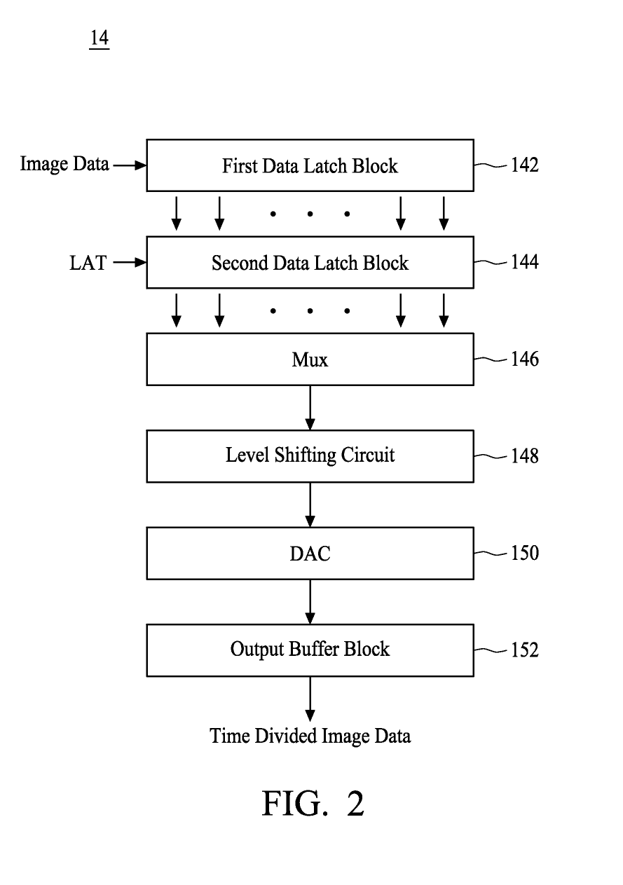

FIG. 3 is a schematic block diagram illustrating a panel display device according to an embodiment of the present invention;

FIG. 4 is a schematic block diagram illustrating a memory array according to an embodiment of the present invention;

FIG. 5 is a schematic block diagram illustrating a memory block according to an embodiment of the present invention;

FIG. 6 is a schematic block diagram illustrating a source driver according to an embodiment of the present invention;

FIG. 7 is a schematic block diagram illustrating a conversion unit according to an embodiment of the present invention; and

FIG. 8 illustrates the operations of a panel display device according to an embodiment of the present invention.

### DESCRIPTION OF THE EMBODIMENTS

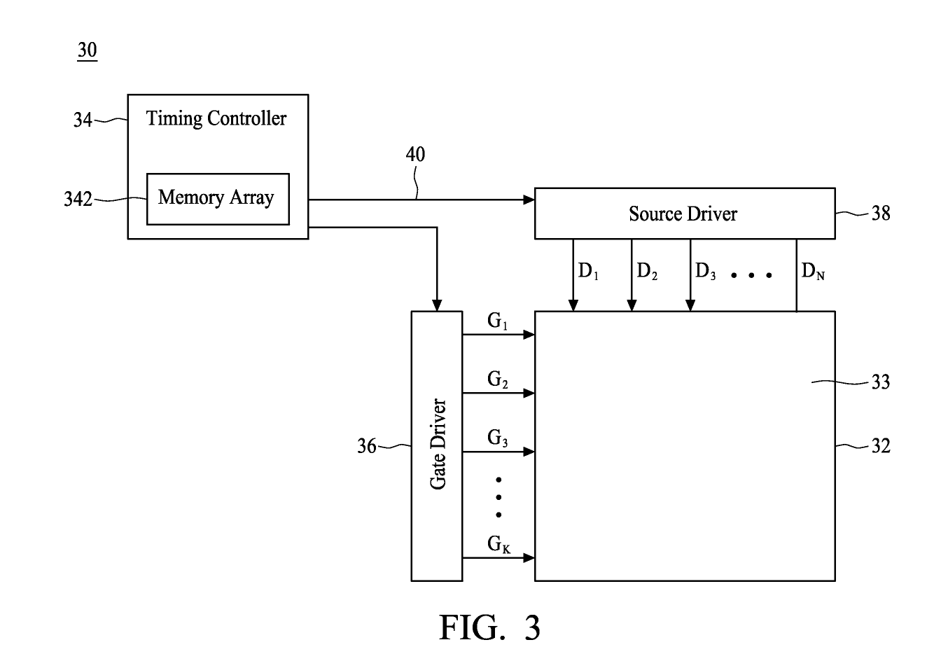

FIG. 3 is a schematic block diagram illustrating a panel display device 30 according to an embodiment. The panel display device 30 includes a display panel 32, a timing controller 34, a source driver 38 and a gate driver 36. Referring to FIG. 3, the display panel 32 includes N regularly spaced data lines D₁-D_{N}, K regularly spaced gate lines G₁-G_{K} perpendicular to the data lines, and a pixel array 33 including a plurality of sub-pixels representing the three primary colors, red, green and blue (RGB), respectively. During operation, the gate driver 36 scans each gate line G₁-G_{K} in sequence, so that each row of pixels is turned on in sequence from top to bottom. Meanwhile, the source driver 38 outputs a corresponding data signal to a full row of pixels through the data lines D₁-D_{N} to charge the pixels to their respective display voltages, so as to display different gray scales. Because each pixel consists of three sub-pixels, each of the data line D₁-D_{N} would output one of the R data, G data and B data in a time division manner to the corresponding sub-pixel.

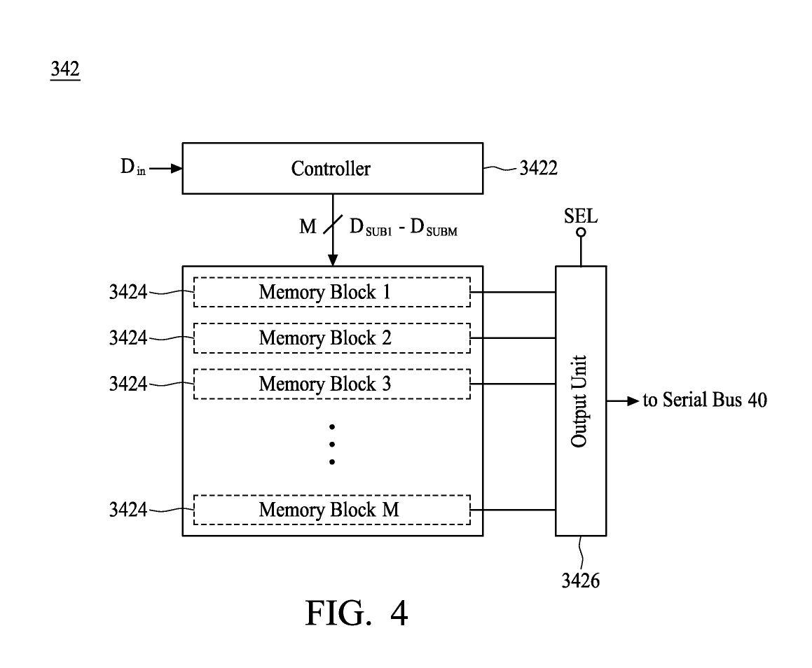

Referring to FIG. 3, the timing controller 34 includes a memory array 342. The memory array 342 sends data to the source driver 38 through a serial bus 40. FIG. 4 is a schematic block diagram illustrating the memory array 342. Referring to FIG. 4, the memory array 342 includes a controller 3422, M memory blocks 3424 and an output unit 3426, wherein M is a positive integer. The controller 3422 is configured to receive serial image data Dᵢₙ, and divide the image data Dᵢₙ into M groups of sub-image data D_{SUB1}-D_{SUBM}. Next, the controller 3422 writes each group of sub-image data into a corresponding memory block in sequence. Thereafter, the output unit 3426 outputs the data in the M memory blocks in sequence in a time division manner to the source driver 38.

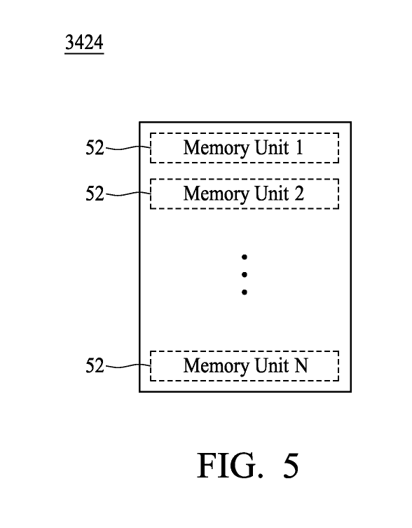

FIG. 5 is a schematic block diagram illustrating the memory block 3424 according to an embodiment. Referring to FIG. 5, the memory block 3424 includes N memory units 52, and each memory unit is configured to store data of D bits, wherein D is a positive integer.

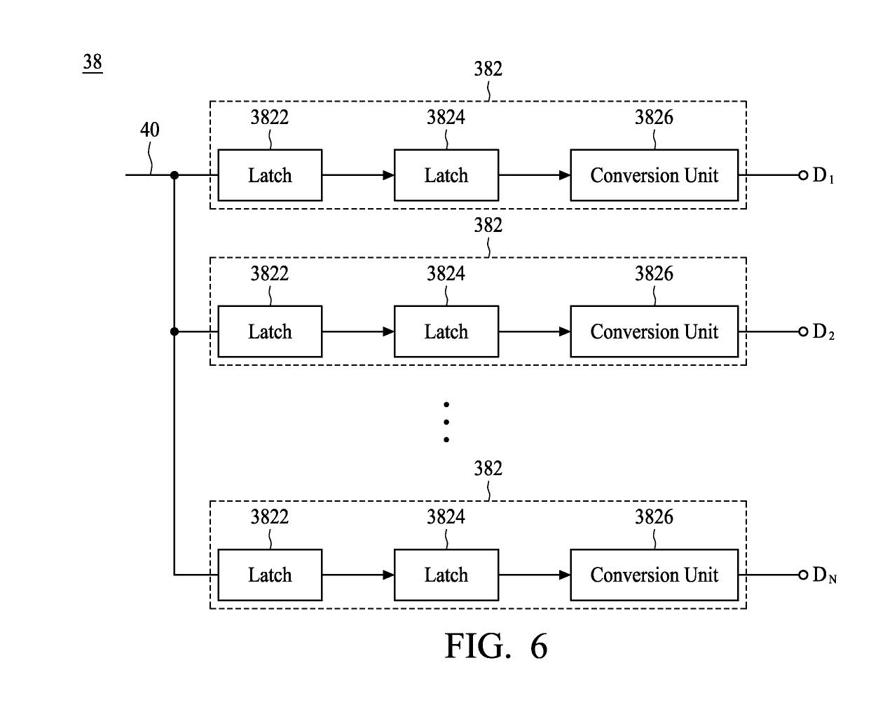

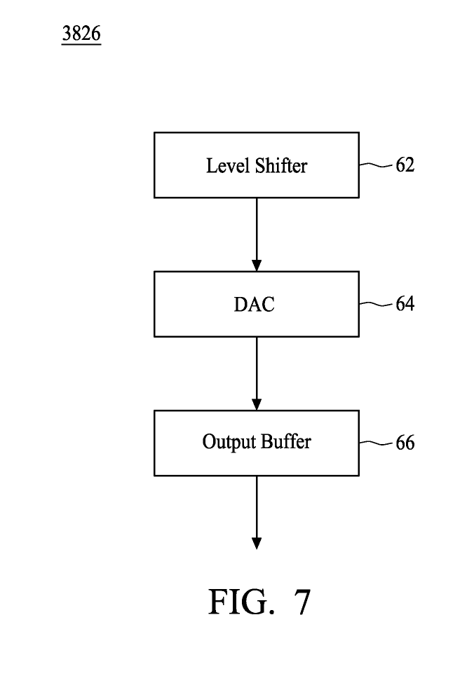

FIG. 6 is a schematic block diagram illustrating the source driver 38 according to an embodiment. Referring to FIG. 6, the source driver 38 includes N driving units 382 having the same configuration. Each driving unit 382 includes a first latch 3822, a second latch 3824 and a conversion unit 3826. FIG. 7 is a schematic block diagram illustrating the conversion unit 3826 in accordance with an embodiment. Referring to FIG. 7, the conversion unit 3826 includes a level shifter 62, a digital to analog converter (DAC) 64 and an output buffer 66.

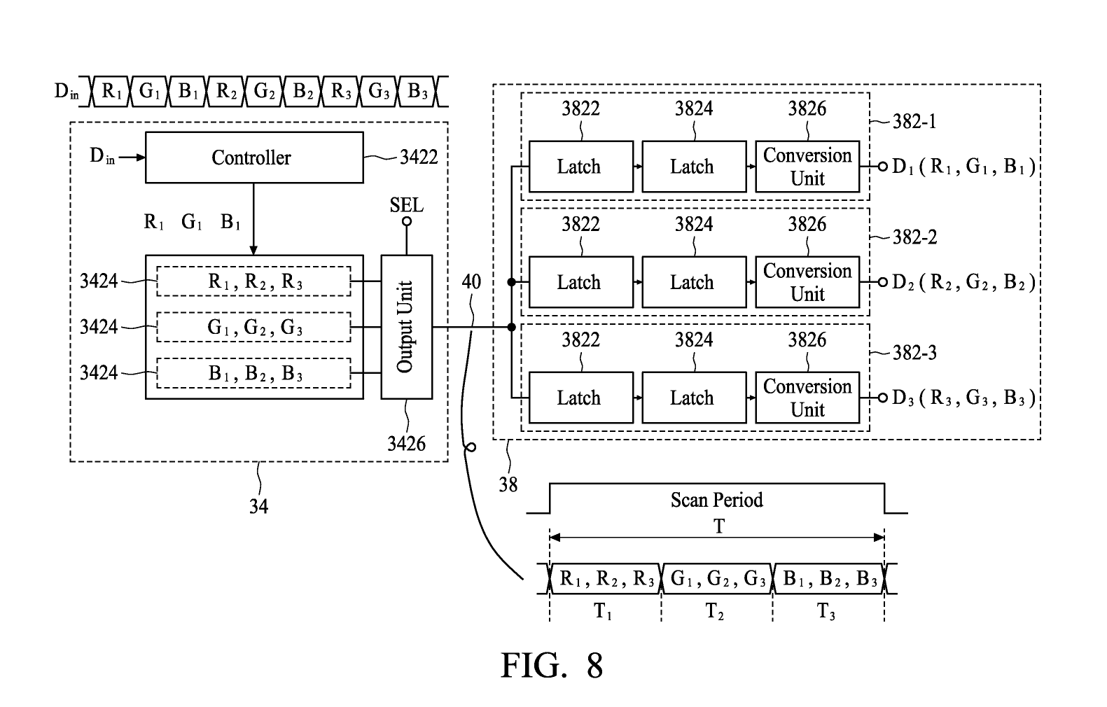

In the following, by reference to FIG. 8 the operations of the panel display device 30 in accordance with an embodiment are described. In order to simplify the description, the display panel 32 is represented by 3 data lines D₁-D₃. In the present embodiment, the serial image data Dᵢₙ received by the controller 3422 is composed of serial RGB data, which has the data format R₁-G₁-B₁-R₂-G₂-B₂-R₃-G₃-B₃, and each R data, G data and B data has a 6-bit length. Thus, the controller 3422 would first divide the image data Dᵢₙ into 3 groups of sub-pixel data, wherein the first group of sub-pixel data is composed of sub-pixel data R₁, R₂ and R₃; the second group of sub-pixel data is composed of sub-pixel data G₁, G₂ and G₃; and the third group of sub-pixel data is composed of sub-pixel data B₁, B₂ and B₃. Next, the controller 3422 writes the first group of sub-pixel data R₁, R₂ and R₃ in sequence to the memory units 1, 2 and 3 of the memory block 1, the second group of sub-pixel data in sequence to the memory units 1, 2 and 3 of the memory block 2, and the third group of sub-pixel data in sequence to the memory units 1, 2 and 3 of the memory block 3. In the present embodiment, the memory blocks 1, 2, and 3 are static random access memory (SRAM) memory blocks, and each memory block includes 3 memory units, wherein each memory unit stores 6-bit sub-pixel data correspondingly.

Thereafter, the output unit 3426 would select the data of the memory blocks 1, 2, and 3 for output in sequence in response to a selection signal SEL. The selection signal SEL may be generated based on an arrangement of color filters. According to an embodiment, the output unit 3426 can be implemented by a time division multiplexer. That is, the output unit 3426 would output the first group, second group and third group of sub-pixel data in a scan period T using a common channel 40 in a time division manner.

Referring to FIG. 8, during the sub-period T₁, the output unit 3426 outputs the sub-pixel data R₁ of the first group of sub-pixel data to the latch 3822 of the driving unit 382_1 of the source driver 38, the sub-pixel data R₂ to the latch 3822 of the driving unit 382_2, and the sub-pixel data R₃ to the latch 3822 of the driving unit 382_3. According to the present embodiment, the latch 3822 is designed to be able to receive and latch a 6-bit data. Then, the second latch 3824 in the driving unit 382_1, 382_2, 382_3 simultaneously receives and latches the data output from the first latch 3822 in response to a latching signal LAT.

Referring concurrently to FIG. 7 and FIG. 8, the level shifter 62 is coupled to the output of the second latch 3824, and is configured to modify the voltage level of the received sub-pixel data. The digital to analog converter 64 is coupled to the output of the level shifter 62, and converts the voltage level modified sub-pixel data into an analog sub-pixel signal. The output buffer 66 is coupled to the digital to analog converter 64 and buffers the sub-pixel signal output from the digital to analog converter 64, and outputs a signal to the corresponding data line. Therefore, during the sub-period T₁, after the gate driver 36 outputs a scan signal, the data lines D₁, D₂ and D₃ would output sub-pixel data R₁, R₂ and R₃, respectively.

Then, during the sub-period T₂, the output unit 3426 outputs the sub-pixel data G₁ of the second group of sub-pixel data recorded in the memory block 2 to the latch 3822 of the driving unit 382_1, the sub-pixel data G₂ to the latch 3822 of the driving unit 382_2, and the sub-pixel data G₃ to the latch 3822 of the driving unit 382_3. Based on the foregoing data processing method, during the sub-period T₂, after the gate driver 36 outputs the scan signal, the data lines D₁, D₂ and D₃ would output sub-pixel data G₁, G₂, and G₃, respectively. Then, during the sub-period T₃, the output unit 3426 outputs the sub-pixel data B₁, the sub-pixel data B₂ and the sub-pixel data B₃ of the third group of sub-pixel data recorded in the memory block 3 to the corresponding latches 3822 of the driving units. Similarly, during the sub-period T₃, after the gate driver 36 outputs the scan signal, the data lines D₁, D₂ and D₃ output sub-pixel data B₁, B₂ and B₃, respectively.

According to the present embodiment, the data output from the output unit 3426 during the sub-periods T₁, T₂ and T₃ are the first group, second group and third group of sub-pixel data in sequence. However, the present invention is not limited to such implementation. The data output from the output unit 3426 during the sub-periods T₁, T₂ and T₃ may be determined by the arrangement of the color filters, which are located above the pixel array 33 of the display panel 32, and the output unit 3426 outputs the three groups of sub-pixel data in a different order in sequence.

In the present embodiment, the serial image data Dᵢₙ received by the controller 3422 consists of RGB data. However, the present invention is not to be thus limited. In another embodiment, the serial image data Dᵢₙ received by the controller 3422 consists of odd-point sampling data and even-point sampling data. Hence, the memory block 1 would store the odd-point sampling data, and the memory block 2 would store the even-point sampling data. The output unit 3426 time divides the received two sampling data (i.e., a scan period T is divided into two sub-periods T₁ and T₂) and outputs through a common channel. Therefore, after the source driver receives the time-divided sampling data, it would output a signal related to the time-divided sampling data to each data line. The panel driving device according to the present invention requires fewer latches to latch data, and does not need any multiplexer to carry out time division operations, thereby significantly simplifying the circuit structure, and reducing the layout area.

The above-described embodiments are intended to be illustrative only. Numerous alternative embodiments may be devised by those skilled in the art without departing from the scope of the following claims.

What is claimed is:

1. A panel driving device for driving a display panel comprising N data lines, wherein N is a positive integer, the panel driving device comprising:
a memory array, comprising:
M memory blocks, each memory block comprising N memory units, each memory unit being configured to store data of D bits, wherein M and D are positive integers;
a controller, configured to divide serial image data into M groups of sub-image data, and write each group of sub-image data into the corresponding memory block in sequence, wherein each group of sub-image data has N sub-image data, and each sub-image data has a data length of D bits; and
an output unit, configured to output the data in the M memory blocks in sequence in a time division manner in response to a selection signal; and
a source driver, comprising N driving units having the same configuration, each driving unit comprising:
a first latch, configured to receive and latch the time-divided data of the output unit;
a second latch, configured to latch the data output from the first latch in response to a latching signal; and
a conversion unit, coupled to one of the N data lines, and configured to convert the data output from the second latch into an image signal, which is output to the corresponding data line.

2. The panel driving device according to claim 1, wherein the memory array is located in a timing controller.

3. The panel driving device according to claim 1, wherein the memory array is a static random access memory (SRAM) memory array.

4. The panel driving device according to claim 1, wherein the controller divides the serial image data into three groups of sub-image data, and each group of sub-image data has N sub-pixel data.

5. The panel driving device according to claim 1, wherein the controller divides the serial image data into two groups of sub-image data, wherein the first group of sub-image data consists of odd-point sampling data, and the second group of sub-image data consists of even-point sampling data.

6. The panel driving device according to claim 1, wherein the conversion unit comprises:
a level shifter, coupled to an output of the second latch, and configured to modify a voltage level of an output signal of the second latch;
a digital to analog converter, coupled to an output of the level shifter, and configured to convert the output signal of the level shifter into an analog signal; and
an output buffer, coupled to an output of the digital to analog converter, and configured to buffer the output signal of the digital to analog converter as a sub-image signal and output the sub-image signal to the corresponding data line.

7. The panel driving device according to claim 1, wherein the selection signal is generated based on an arrangement of color filters on the display panel.

8. A panel display device, comprising:
a display panel, having N data lines, wherein N is a positive integer;
a memory array, comprising:
M memory blocks, each memory block comprising N memory units, each memory unit being configured to store data of D bits, wherein M and D are positive integers;
a controller, configured to divide serial image data into M groups of sub-image data, and write each group of sub-image data into the corresponding memory block in sequence, wherein each group of sub-image data has N sub-image data, and each sub-image data has a data length of D bits; and
an output unit, configured to output the data in the M memory blocks in sequence in a time division manner in response to a selection signal; and
a source driver, comprising N driving units having the same configuration, each driving unit comprising:
a first latch, configured to receive and latch the time-divided data of the output unit;
a second latch, configured to latch the data output from the first latch in response to a latching signal; and
a conversion unit, coupled to one of the N data lines, and configured to convert the data output from the second latch into an image signal, which is output to the corresponding data line.

9. The panel display device according to claim 8, wherein the controller divides the serial image data into three groups of sub-image data, and each group of sub-image data has N sub-pixel data.

10. The panel display device according to claim 8, wherein the controller divides the serial image data into two groups of sub-image data, wherein the first group of sub-image data consists of odd-point sampling data, and the second group of sub-image data consists of even-point sampling data.

11. The panel display device according to claim 8, wherein the conversion unit comprises:
a level shifter, coupled to an output of the second latch, and configured to modify a voltage level of an output signal of the second latch;
a digital to analog converter, coupled to an output of the level shifter, and configured to convert the output signal of the level shifter into an analog signal; and
an output buffer, coupled to an output of the digital to analog converter, and configured to buffer the output signal of the digital to analog converter as a sub-image signal and output the sub-image signal to the corresponding data line.

12. The panel display device according to claim 8, wherein the selection signal is generated based on an arrangement of color filters on the display panel.
